(19) United States
(12) Patent Application Publication
(10) Pub. No.: US 2011/0173973 A1
(43) Pub. Date: Jul. 21, 2011

(54) TURBINE INLET FLOW MODULATOR

(75) Inventors: Luis Carlos Cattani, Aurora, IL (US); John Zagone, Westmont, IL (US); Paul Gottemoller, Palos Park, IL (US); James P. Burke, Naperville, IL (US)

(73) Assignee: International Engine Intellectrual Property Company, LLC, Warrenville, IL (US)

(21) Appl. No.: 12/985,640

(22) Filed: Jan. 6, 2011

Related U.S. Application Data
(60) Provisional application No. 61/296,601, filed on Jan. 20, 2010.

(51) Int. Cl. F02C 6/12; F01D 17/12; B23P 15/00

(52) U.S. Cl. 60/602; 415/157; 29/888.024

(57) ABSTRACT

A turbine (22T) of a turbocharger (22) has a housing (24), a turbine wheel (30) disposed within an interior of the housing on a shaft (32) for rotation with the shaft about an axis of rotation (34). A scroll (38) directs a gas toward the axis for imparting rotation to the turbine wheel and shaft. A ring (44) is concentric with the axis and is selectively positionable along the axis for selectively restricting gas directed from the scroll toward the axis. A mechanism (48), including a first-class lever (86) pivotally mounted on the housing, positions the ring along the axis.

### TECHNICAL FIELD

This disclosure relates to internal combustion engines, such as diesel engines for propelling motor vehicles, and to charging devices that comprise turbines operated by engine exhaust gas for creating superatmospheric pressure, i.e. boost, in intake manifolds through which charge air enters engine cylinders to support combustion.

### BACKGROUND

Engine exhaust backpressure plays a significant role in both engine performance and control of tailpipe emissions. An engine that comprises a turbocharger having a turbine operated by engine exhaust gas can control engine exhaust backpressure as one aspect of an overall engine control strategy embodied in an engine control system.

A variable geometry turbine (VGT) is one example of such a turbine. It is known to use a VGT for “driving” exhaust gas recirculation (EGR) at low engine speeds.

It is also known to drive EGR by intake throttle control as another aspect of an overall engine control strategy, either without, or in conjunction with, a turbine control strategy. The use of an intake throttle control strategy may however result in unintended consequences that adversely affect engine performance, fuel economy, and certain tailpipe emissions, such as soot.

### SUMMARY OF THE DISCLOSURE

This disclosure relates to a turbine comprising a turbine inlet flow modulator having a ring which is concentric with a turbine wheel axis of rotation and which can be selectively positioned axially of a turbine wheel to modulate engine exhaust flow entering an interior of a turbine housing through a scroll. As the ring is being positioned toward increasingly restricting engine exhaust flow directed toward the turbine wheel, the turbine increases engine backpressure. The ring position sets the throat area through which engine exhaust leaves the scroll such that for a given flow rate, the expansion ratio increases, thereby increasing energy input to the turbine wheel, energy which causes the compressor to increase boost.

Selectively restricting exhaust flow directed toward the turbine wheel can substantially maintain a desired air-fuel (A/F) ratio while substantially avoiding both a significant brake specific fuel consumption (BSFC) penalty and a significant increase in tailpipe soot.

Apart from the aforementioned effects on A/F ratio, BSFC and soot generation, the turbine inlet flow modulator, in conjunction with its effect on the compressor, can provide engine braking, either alone or in combination with a bleeder brake system or compression release brake system.

A turbine comprising the disclosed turbine inlet flow modulator is capable of effectively driving EGR when an engine is developing low engine exhaust backpressure, such as at low engine speeds.

A turbine comprising the disclosed turbine inlet flow modulator is capable of effectively operating as an engine brake, either alone or by assisting a compression release or bleeder brake to create higher boost that results in increased engine retarding power.

A turbine comprising the disclosed turbine inlet flow modulator is capable of effective use in after-treatment (A/T) thermal management, potentially in either replacement or augmentation of an exhaust valve in the exhaust system downstream of the turbine. A/T thermal management may be used to increase exhaust gas temperature high enough to initiate diesel oxidation catalyst (DOC) light-off. Increasing engine exhaust gas temperature, especially at low engine load conditions, can promote passive catalyst regeneration in certain engine map areas, thereby promoting fuel economy by reducing the frequency of active regeneration.

A turbine comprising the disclosed turbine inlet flow modulator can function as a cold start aid that promotes more rapid engine warm-up during cold start and at light engine load by increasing engine exhaust backpressure and as a consequence rapidly elevating exhaust temperature.

The disclosed turbine inlet flow modulator comprises a mechanism that is actuated either pneumatically, hydraulically, electrically, or mechanically. While the positionable ring is disposed within an interior of the turbine housing, the actuator can be mounted on an exterior of the housing and operatively coupled with the ring by a mechanism that passes through holes in a wall of the housing so as not to infringe on the exhaust flow path through the turbine.

The ring has an aerodynamic shape and can be actuated from either hub side or turbine shroud side of a turbocharger. The ring is imperforate except for several pressure balance holes extending through the ring from one axial face to an opposite axial face. Unlike a VGT, the disclosed turbine inlet flow modulator has no pivoting vanes, an aspect that renders a turbine more robust because it reduces complexity and can increase reliability and efficiency.

One aspect of the disclosure relates to an internal combustion engine comprising engine cylinders within which combustion of fuel occurs to operate the engine, an intake system for conveying air to the engine cylinders to support the combustion of fuel, an exhaust system for conveying combustion-created exhaust from the engine cylinders, and a turbocharger comprising a turbine operated by exhaust being conveyed through the exhaust system.

The turbocharger comprises a housing and a turbine wheel disposed within an interior of the housing on a shaft for rotation with the shaft about an axis of rotation and a compressor operated by the shaft for compressing air being conveyed through the intake system to develop engine boost.

The housing comprises a scroll through which exhaust is directed toward the axis to impart rotation to the turbine wheel and shaft.

A ring which is concentric with the axis is selectively positionable along the axis relative to the housing for selectively restricting exhaust directed from the scroll toward the axis.

An actuator comprises a movable part that acts through a mechanism having a first-class lever to position the ring along the axis.

Another aspect of the disclosure relates to a turbine comprising a housing and a turbine wheel disposed within an interior of the housing on a shaft for rotation with the shaft about an axis of rotation. The housing comprises a scroll through which a gas is directed toward the axis to impart rotation to the turbine wheel and shaft. A ring that is concentric with the axis is selectively positionable along the axis relative to the housing for selectively restricting gas directed from the scroll toward the axis. A mechanism that comprises a first-class lever positions the ring along the axis.

Another aspect of the disclosure relates to a turbine comprising a housing and a turbine wheel disposed within an interior of the housing on a shaft for rotation with the shaft about an axis of rotation. The housing comprises a scroll through which a gas is directed toward the axis to impart rotation to the turbine wheel and shaft. A ring that is concentric with the axis is selectively positionable along the axis relative to the housing for selectively restricting gas directed from the scroll toward the axis. The ring comprises a profile that in longitudinal cross section has a radially outer wall parallel to the axis, a radially inner wall parallel to the axis, and a curved wall that joins the inner and outer walls and comprises a convex control surface cooperating with a confronting surface to form a throat through which gas passes from the scroll toward the axis. A mechanism positions the ring along the axis relative to the confronting surface to set the throat area.

Another aspect of the disclosure relates to a method of making a turbine that comprises disposing a turbine wheel and shaft within an interior of a housing for rotation about an axis of rotation, the housing comprising a scroll having a throat area through which a gas is directed from the scroll toward the axis for imparting rotation to the turbine wheel and shaft, disposing an axially positionable ring concentric with the axis within the housing interior for varying the throat area, disposing a first-class lever exterior to the housing, and operatively coupling the first-class lever through the housing to the ring to cause pivoting of the first-class lever to axially position the ring.

The foregoing summary is accompanied by further detail of the disclosure presented in the Detailed Description below with reference to the following drawings that are part of the disclosure.

### BRIEF DESCRIPTION OF THE DRAWINGS

FIG. 1 is a general schematic diagram of a diesel engine having a turbocharger.

FIG. 2 is perspective view of a turbine of the turbocharger.

FIG. 3 is a front side elevation view of FIG. 2.

FIG. 4 is a left end elevation view of FIG. 3.

FIG. 5 is a right end elevation view of FIG. 3.

FIG. 6 is a perspective view of one component of the turbine by itself.

FIG. 7 is a perspective view of the component of FIG. 6 from a different direction.

FIG. 8 is a perspective view of the component of FIG. 6 from still another direction, including additional components of the turbine.

FIG. 9 is a longitudinal cross section view through the turbine.

FIG. 10 is an enlarged view of a portion of FIG. 9.

FIG. 11 is a view of a portion of another embodiment.

FIG. 12 is a view of a portion of another embodiment.

### DETAILED DESCRIPTION

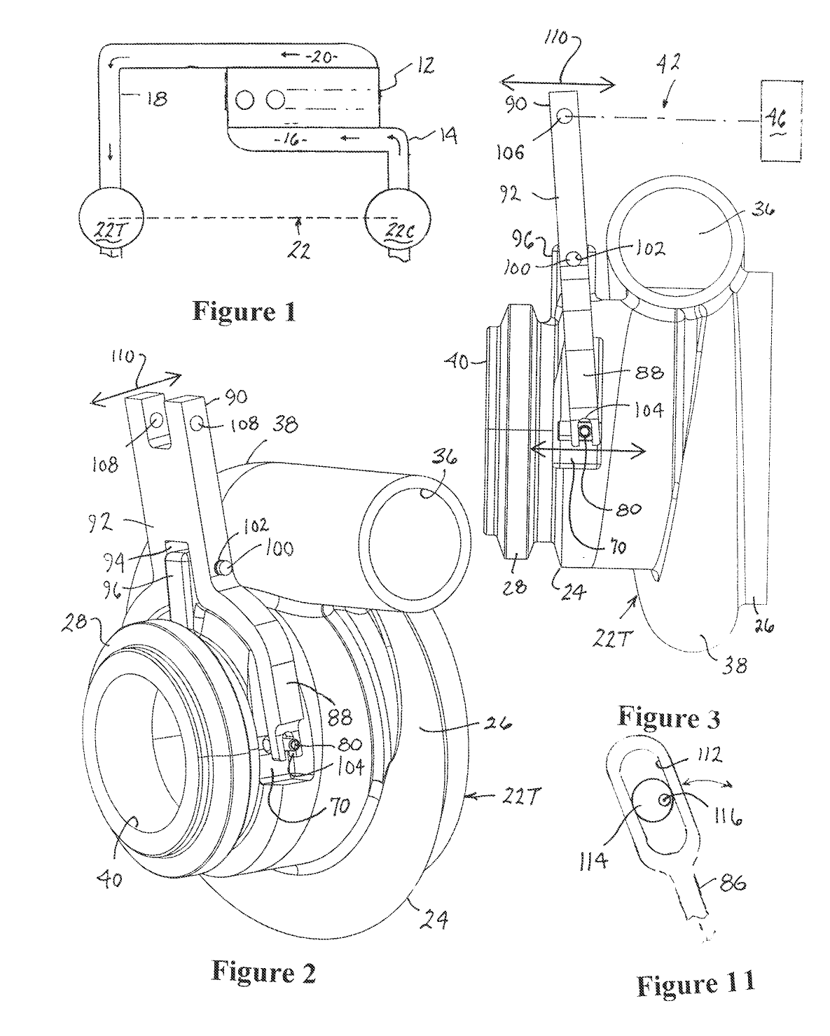

FIG. 1 shows a multi-cylinder engine 12 having structural components assembled together to form engine cylinders within which combustion of fuel occurs to operate a kinematic mechanism comprising pistons, connecting rods, and a crankshaft. Fresh air for supporting combustion of fuel is delivered to cylinders of engine 12 through an intake system 14 that comprises an intake manifold 16 serving the engine cylinders.

Engine 12 further comprises an exhaust system 18 that comprises an exhaust manifold 20 at which combustion-created exhaust from the engine cylinders enters the exhaust system for conveyance to a tailpipe through which the exhaust passes into the surrounding atmosphere. Various other components and devices that may be present in the intake and exhaust systems are not shown. A turbocharger 22 that comprises a turbine 22T in exhaust system 18 and a compressor 22C in intake system 14 is an exception.

FIG. 1 shows engine exhaust leaving exhaust manifold 20 and passing through turbine 22T before continuing through the remainder of exhaust system 18 to the tailpipe. The exhaust that passes through turbine 22T operates turbocharger 22 to cause compressor 22C to compress air passing through the intake system 14, thereby developing boost for engine 12.

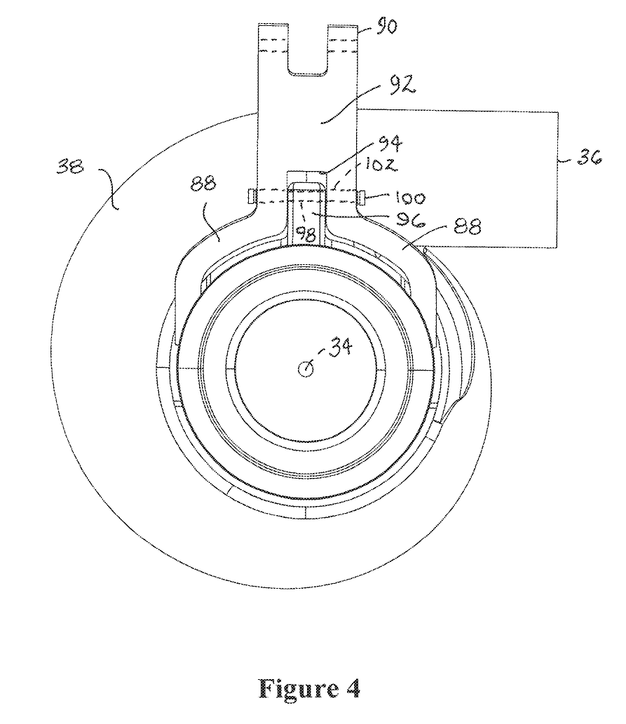

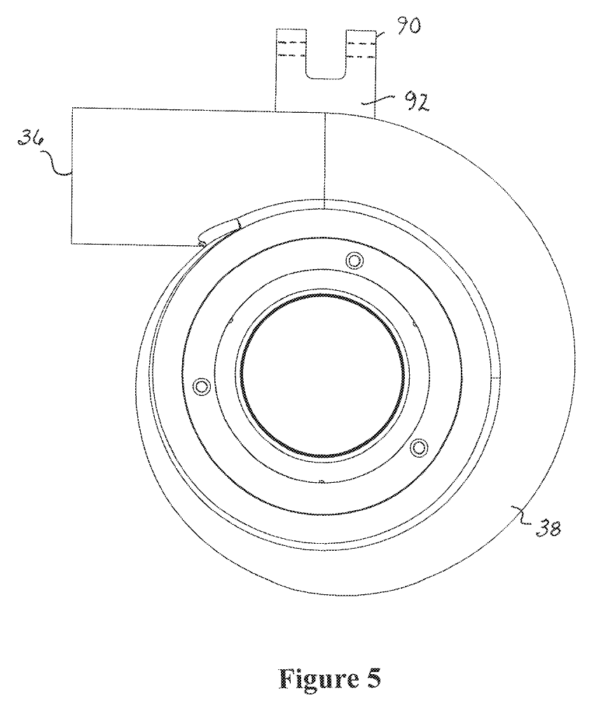

Details of turbine 22T are shown in FIGS. 2-10. Turbine 22T comprises a housing 24 which comprises a first housing part 26 and a second housing part 28 that are assembled together to form an interior of the housing.

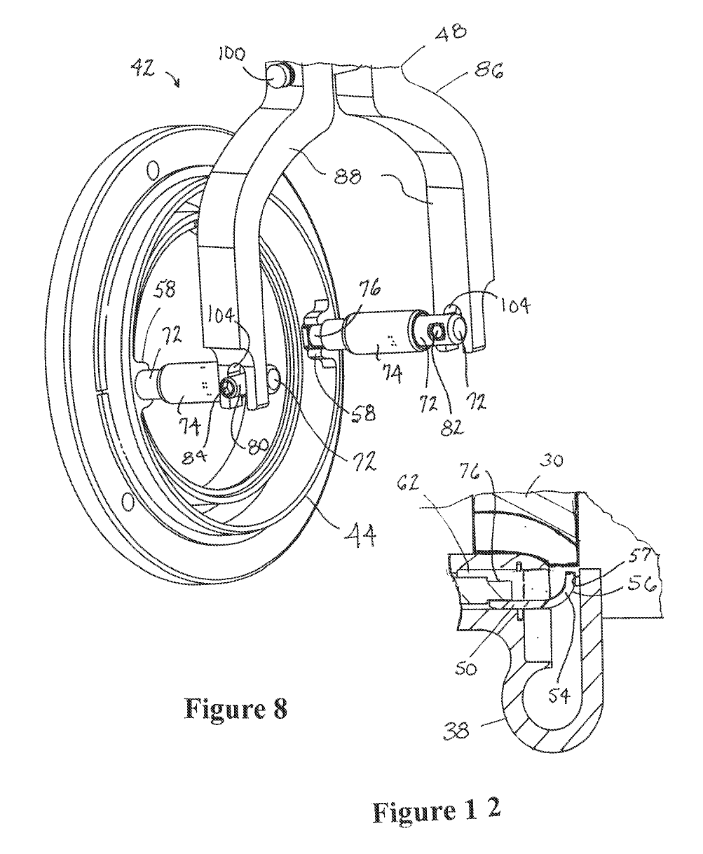

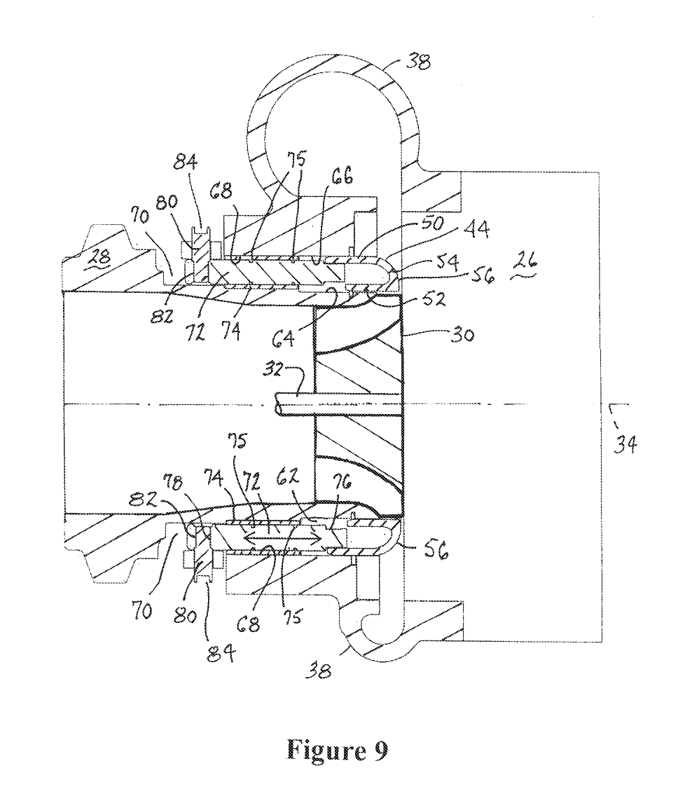

A turbine wheel 30 (FIG. 9) is disposed within the housing interior on a shaft 32 for rotation with the shaft about a longitudinal axis of rotation 34. Shaft 32 is suitably supported on housing 24 for rotation to also rotate a compressor wheel of compressor 22C.

Second housing part 28 comprises an exhaust inlet 36 through which exhaust coming from cylinders of engine 12 enters a scroll 38 of second housing part 28. Second housing part 28 further comprises an exhaust outlet 40 through which exhaust that has passed through housing 24 leaves turbine 22T. Engine exhaust that enters exhaust inlet 36 is directed by scroll 38 inwardly toward axis 34. As inwardly directed exhaust traverses vanes of turbine wheel 30, force applied by the exhaust to the vanes has a component that due to vane shape applies torque that rotates turbine wheel 30 and shaft 32. After acting on the vanes, exhaust then flows generally axially to exit the housing interior through exhaust outlet 40.

Turbine 22T also comprises an inlet flow modulator 42 which comprises a ring 44 that is concentric with axis 34. Ring 44 is selectively positionable along axis 34 relative to housing 24 for selectively restricting exhaust directed from scroll 38 toward axis 34.

FIG. 3 shows an actuator 46 exterior to the housing interior as a prime mover for positioning ring 44. Actuator 46 has a movable part that is operatively coupled with ring 44 via a mechanism 48. Actuator 46 may be a pneumatically-, hydraulically-, or electrically-operated device, and the movable part, a member that is displaceable in a generally linear direction for imparting a force component to mechanism 48 that results in movement of ring 44.

Ring 44 comprises a radially outer circular wall 50, a radially inner circular wall 52, and a curved wall 54 joining axial ends of outer wall 50 and inner wall 52 that are toward exhaust outlet 40. Curved wall 54 has a convex control surface 56 that, as shown in FIG. 10, curves inward toward axis 34 as it confronts a radial surface 57 of second housing part 28 to form a throat through which engine exhaust leaves scroll 38.

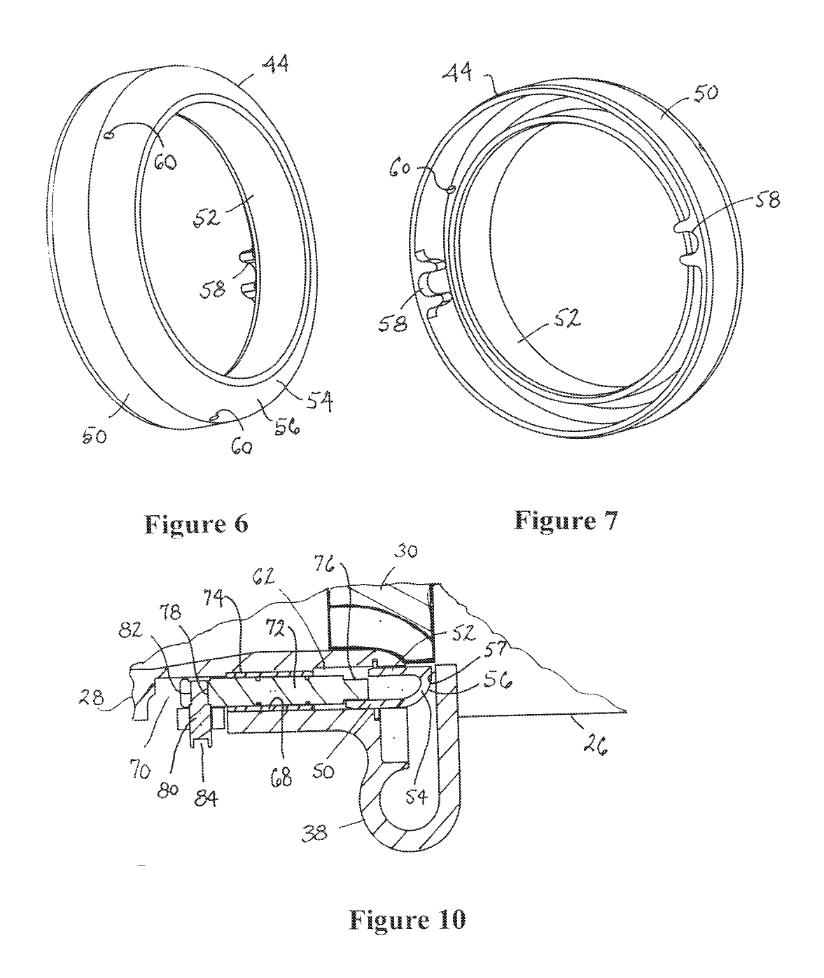

FIGS. 6 and 7 show ring 44 to further comprise clevises 58 diametrically opposite each other at an axial end of outer circular wall 50 opposite control surface 56. Inner circular wall 52 stops short of that axial end of outer circular wall 50. Clevises 58 extend radially inward from an inner surface of outer circular wall 50. Ring 44 has several pressure balance holes 60 extending from control surface 56 through curved wall 54 to the opposite surface.

FIG. 10 shows second housing part 28 to have a circular groove 62 concentric with axis 34. FIG. 9 shows groove 62 bounded by a radially inner circular surface 64 and a radially outer circular surface 66. Outer circular wall 50 of ring 44 fits with close clearance to groove 62 to allow ring 44 to retract into groove 62 from the position of ring 44 shown in FIG. 10.

Second housing part 28 has two circular holes 68 that are diametrically opposite each other and that extend axially from groove 62 to a recess 70 on the exterior of housing part 28. A respective shaft 72 extends through each hole 68 within a respective cylindrical bushing 74 that is pressed into a respective hole 68. Metal O-rings 75 that are spaced axially apart around the outside of each bushing seal each bushing to the respective hole 68.

An end portion of each shaft 72 that is axially toward ring 44 comprises a circumferential groove 76 that fits the respective shaft to a respective clevis 58. An end portion of each shaft 72 that is axially opposite the respective circumferential groove 76 comprises a hole 78 that extends diametrically through the respective shaft 72.

One end of a respective post 80 comprises a thread 82 that threads the respective post 80 to the respective hole 78. The opposite end of each post 80 comprises a head 84 providing a tool-engagement surface that can be engaged by a suitable tool for tightening the post to the respective shaft 72.

Mechanism 48 further comprises a first class-lever 86 having one lever arm that comprises a pair of curved arms 88 symmetric about axis 34 and straddling housing 24 on the exterior. The other lever arm 90 of lever 86 comprises a clevis 92 at its far end. Between its two lever arms, first-class lever 86 comprises a slot 94 that forms a clevis for fitting lever 86 closely to a fulcrum 96 that is part of second housing part 28. Fulcrum 96 comprises a clevis hole 98. A pivot pin 100 extends through a first of two clevis holes 102 in lever 86, clevis hole 98, and a second of the two clevis holes 102 to pivotally mount first-class lever 86 on the exterior of housing 24. The ends of curved arms 88 comprise slots 104 that fit to portions of posts 80 that protrude outward from shafts 72. A pin 106 passes through holes 108 in clevis 90 and a hole in the movable part of actuator 46 that fits to the clevis to connect the movable part of actuator 46 to lever 86.

The movable part of actuator 46 positions ring 44 by exerting either a pulling force or a pushing force component, as indicated by arrow 110 in FIGS. 2 and 3, on lever 86. The force component acts in a direction tangent to an arc concentric with the axis of pivot pin 100 about which lever 86 pivots. FIGS. 2 and 3 show ring 44 in a retracted position corresponding to ring 44 being maximally within groove 62 and axial distance between control surface 56 and surface 57 being a maximum.

When a pulling force is exerted on lever arm 90, lever 86 pivots clockwise on pivot pin 100 as viewed in FIG. 3 to cause curved arms 88 to push posts 80 to the left in that Figure. With the posts being fast to shafts 72, the latter are pushed within bushings 74 to move ring 44 outwardly of groove 62 and decrease axial distance between control surface 56 and surface 57.

When a pushing force is exerted on lever 86 by the movable part of actuator 46 while ring 44 is in a position other than maximally retracted within groove 62, the lever pivots counterclockwise about pivot pin 100 as viewed in FIG. 3 to cause curved arms 88 to pull posts 80, and hence shafts 72, to the right in that Figure, pulling ring more fully into groove 62 to increase axial distance between control surface 56 and surface 57.

FIG. 11 shows a different actuator for operating lever 86. Clevis 90 is replaced by a slot formation 112 in first-class lever 86. An eccentric 114 that can turn about an axis of turning 116 is captured by formation 112. This actuator causes first-class lever 86 to pivot on pivot pin 100 in correlation with turning of eccentric 114 thereby causing ring 44 to be positioned in correlation with turning of eccentric 114. The speed at which eccentric 114 turns controls the speed at which ring 44 moves during positioning. Control by a rotary actuator such as eccentric 114 and its interaction with slot formation 112 may provide greater control accuracy and more control versatility than a linear actuator in some cases, thereby resulting in more precise positioning control of ring 44.

FIG. 12 shows a different ring 44 whose profile in longitudinal cross section comprises only radially outer circular wall 50 and curved wall 54. Because of the absence of radially inner circular wall 52, this embodiment may not use pressure balance holes 60.

What is claimed is:

1. An internal combustion engine comprising:
engine cylinders within which combustion of fuel occurs to operate the engine;
an intake system for conveying air to the engine cylinders to support the combustion of fuel;
an exhaust system for conveying combustion-created exhaust from the engine cylinders;
a turbocharger comprising a turbine operated by exhaust being conveyed through the exhaust system,
the turbocharger comprising a housing and a turbine wheel disposed within an interior of the housing on a shaft for rotation with the shaft about an axis of rotation and a compressor operated by the shaft for compressing air being conveyed through the intake system,
the housing comprising a scroll through which exhaust is directed toward the axis to impart rotation to the turbine wheel and shaft,
a ring that is concentric with the axis and is selectively positionable along the axis relative to the housing for selectively restricting exhaust directed from the scroll toward the axis,
an actuator that comprises a movable part,
and a mechanism, including a first-class lever pivotally mounted on the housing, through which motion of the movable part positions the ring along the axis.

2. An internal combustion engine as set forth in claim 1 in which the movable part comprises an eccentric that can turn about an axis of turning and is captured by a formation in the first-class lever for causing the first-class lever to pivot on the housing in correlation with turning of the eccentric thereby causing the ring to be positioned in correlation with turning of the eccentric.

3. An internal combustion engine as set forth in claim 2 in which the movable part comprises a member that is displaceable in a generally linear direction for imparting a force component to the first-class lever in a direction tangent to an arc concentric with an axis about which the first-class lever pivots.

4. An internal combustion engine as set forth in claim 1 in which the actuator is disposed exterior to the housing interior, and the first-class lever is pivotally mounted on a fulcrum exterior to the housing.

5. An internal combustion engine as set forth in claim 4 in which the first-class lever comprises arms exterior to the housing on opposite sides of the housing extending from the fulcrum to straddle the housing, the mechanism further comprises shafts disposed diametrically opposite each other about the axis and guided for axial motion by bushings disposed in through-holes in the housing, ends of the arms that straddle the housing are connected to exterior ends of the shafts, and interior ends of the shafts are connected to the ring.

6. An internal combustion engine as set forth in claim 5 in which the through-holes in the housing are open to a circular groove in the housing within which the ring is axially positioned.

7. An internal combustion engine as set forth in claim 5 in which connection of the ends of the arms that straddle the housing to exterior ends of the shafts comprises posts that extend laterally outward from the shafts.

8. An internal combustion engine as set forth in claim 5 in which connection of interior ends of the shafts to the ring comprises devises on the ring to which grooves extending circumferentially around the interior ends of the rings are fit.

9. An internal combustion engine as set forth in claim 1 in which the ring comprises a profile that in longitudinal cross section through the axis has a radially outer wall parallel to the axis, a radially inner wall parallel to the axis, and a curved wall that joins the inner and outer walls and comprises a convex control surface cooperating with a confronting surface to form a throat through which engine exhaust passes from the scroll toward the axis.

10. An internal combustion engine as set forth in claim 9 in which the ring comprises pressure-balance holes extending from the convex control surface of the curved wall to an opposite surface of the curved wall.

11. A turbine comprising:
a housing,
a turbine wheel disposed within an interior of the housing on a shaft for rotation with the shaft about an axis of rotation,
the housing comprising a scroll through which a gas is directed toward the axis for imparting rotation to the turbine wheel and shaft,
a ring that is concentric with the axis and is selectively positionable along the axis relative to the housing for selectively restricting gas directed from the scroll toward the axis,
and a mechanism, including a first-class lever pivotally mounted on the housing, for positioning the ring along the axis.

12. A turbine as set forth in claim 11 in which the movable part comprises an eccentric that can turn about an axis of turning and is captured by a formation in the first-class lever for causing the first-class lever to pivot on the housing in correlation with turning of the eccentric thereby causing the ring to be positioned in correlation with turning of the eccentric.

13. A turbine as set forth in claim 12 in which the movable part comprises a member that is displaceable in a generally linear direction for imparting a force component to the first-class lever in a direction tangent to an arc concentric with an axis about which the first-class lever pivots.

14. A turbine as set forth in claim 11 in which the actuator is disposed exterior to the housing interior, and the first-class lever is pivotally mounted on a fulcrum exterior to the housing.

15. A turbine as set forth in claim 14 in which the first-class lever comprises arms exterior to the housing on opposite sides of the housing extending from the fulcrum to straddle the housing, the mechanism further comprises shafts disposed diametrically opposite each other about the axis and guided for axial motion by bushings disposed in through-holes in the housing, ends of the arms that straddle the housing are connected to exterior ends of the shafts, and interior ends of the shafts are connected to the ring.

16. A turbine as set forth in claim 15 in which the through-holes in the housing are open to a circular groove in the housing within which the ring is axially positioned.

17. A turbine as set forth in claim 15 in which connection of the ends of the arms that straddle the housing to exterior ends of the shafts comprises posts that extend laterally outward from the shafts.

18. A turbine as set forth in claim 15 in which connection of interior ends of the shafts to the ring comprises clevises on the ring to which grooves extending circumferentially around the interior ends of the rings are fit.

19. A turbine as set forth in claim 11 in which the ring comprises a profile that in longitudinal cross section through the axis has a radially outer wall parallel to the axis, a radially inner wall parallel to the axis, and a curved wall that joins the inner and outer walls and comprises a convex control surface cooperating with a confronting surface to form a throat through which gas passes from the scroll toward the axis.

20. A turbine as set forth in claim 19 in which the ring comprises pressure-balance holes extending from the convex control surface of the curved wall to an opposite surface of the curved wall.

21. A turbine comprising:
a housing,
a turbine wheel disposed within an interior of the housing on a shaft for rotation with the shaft about an axis of rotation,
the housing comprising a scroll through which gas is directed toward the axis for imparting rotation to the turbine wheel and shaft,
a ring that is concentric with the axis and is selectively positionable along the axis relative to the housing for selectively restricting gas directed from the scroll toward the axis, the ring comprising a profile that in longitudinal cross section has a radially outer wall parallel to the axis and a curved wall that joins with the radially outer wall and comprises a convex control surface curving toward the axis and cooperating with a confronting surface to form a throat through which gas passes from the scroll toward the axis,
and a mechanism for positioning the ring along the axis relative to the confronting surface to set the area of the throat.

22. A turbine as set forth in claim 21 in which the ring further comprises a radially inner wall that is parallel to the axis and joins with the curved wall.

23. A turbine as set forth in claim 22 in which the ring comprises pressure-balance holes extending from the convex control surface of the curved wall to an opposite surface of the curved wall.

24. A method of making a turbine comprising:
disposing a turbine wheel and shaft within an interior of a housing for rotation about an axis of rotation,
the housing comprising a scroll comprising a throat area through which a gas is directed from the scroll toward the axis for imparting rotation to the turbine wheel and shaft,
disposing an axially positionable ring concentric with the axis within the housing interior for varying the throat area,
disposing a first-class lever exterior to the housing, and
operatively coupling the first-class lever through openings in the housing to the ring to cause pivoting of the first-class lever to axially position the ring.
